(19) United States
(12) Patent Application Publication
(10) Pub. No.: US 2025/0102794 A1
(43) Pub. Date: Mar. 27, 2025

(54) OPTICAL UNIT, OPTICAL APPARATUS, IMAGE PICKUP APPARATUS, LIGHT-SHIELDING FILM, AND LIGHT-SHIELDING COATING MATERIAL

(71) Applicant: CANON KABUSHIKI KAISHA, Tokyo (JP)

(72) Inventor: REIKO KUBOTA, Kanagawa (JP)

(21) Appl. No.: 18/829,623

(22) Filed: Sep. 10, 2024

(30) Foreign Application Priority Data
Sep. 21, 2023 (JP) 2023-155705
Feb. 21, 2024 (JP) 2024-024594

(51) Int. Cl. G02B 27/00

(52) U.S. Cl. CPC G02B 27/0018

(57) ABSTRACT

An optical unit comprises a first optical element, a second optical element, a third optical element that joins the first optical element to the second optical element, and a light-shielding film containing a resin and inorganic particles, disposed in contact with edge faces of the first optical element, the second optical element and the third optical element, wherein the first optical element and/or the second optical element has a chamfered part on the joint surface side, wherein at least one of the first optical element and/or the second optical element having the chamfered part has a round part on the joint surface side, and wherein a resin ratio in the light-shielding film is 87 vol % or more and 95 vol % or less.

### BACKGROUND OF THE INVENTION

### Field of the Invention

The present invention relates to an optical unit, and optical apparatus and image pickup apparatus having the optical unit. Further, the present invention relates to a light-shielding film to be disposed on the surface of an optical unit and a light-shielding coating material.

### Description of the Related Art

A light-shielding film in black color is disposed on the outer region of effective beam aperture of an optical unit for use in an optical apparatus on an as needed basis, so that stray light is reduced.

The light-shielding film is a film formed mainly on the outer region of a member of glass or plastic that composes an optical unit. The glass or plastic member may be a lens or a prism. Alternatively, the glass or plastic member may be other optical glass or optical prisms.

In Japanese Patent Application Laid-Open No. 2020-024331, regarding a cemented lens having a chamfered part, an optical unit of which resin component contains a pigment that adjusts the refractive index is disclosed. Further, in Japanese Patent Application Laid-Open No. 2013-100456, a light-shielding film in black color containing a resin, a colorant and inorganic particles, and an optical unit are disclosed.

### SUMMARY OF THE INVENTION

The present invention relates to an optical unit comprising a first optical element, a second optical element, a third optical element that joins the first optical element to the second optical element, and a light-shielding film containing a resin and inorganic particles, disposed in contact with edge faces of the first optical element, the second optical element and the third optical element, wherein the first optical element and/or the second optical element has a chamfered part on the joint surface side, wherein at least one of the first optical element and/or the second optical element having the chamfered part has a round part on the joint surface side, and wherein a resin ratio in the light-shielding film is 87 vol % or more and 95 vol % or less.

The present invention also relates to an optical apparatus having a casing and the optical unit disposed in the casing.

The present invention also relates to an image pickup apparatus comprising an optical system including a casing and the optical unit disposed in the casing, and an image pickup element that receives light incident through the optical system.

The present invention also relates to a light-shielding film disposed in contact with the edge faces of a first optical element, a second optical element, and a third optical element that joints the first optical element to the second optical element, wherein the light-shielding film contains a resin and inorganic particles, and the light-shielding film has a resin ratio of 87 vol % or more and 95 vol % or less.

The present invention also relates to a light-shielding coating material in black color comprising a resin, a colorant and inorganic particles, wherein the light-shielding coating material contains a dispersant of which amine value is higher than acid value.

Further features of the present invention will become apparent from the following description of exemplary embodiments with reference to the attached drawings.

### BRIEF DESCRIPTION OF THE DRAWINGS

FIG. 1 is a schematic view illustrating a conventionally known light-shielding film, and a lens having the light-shielding film.

FIG. 2 is a schematic cross-sectional view illustrating an interfacial state between a light-shielding film of a conventionally known lens having the light-shielding film and the lens.

FIG. 3 is a schematic cross-sectional view illustrating a conventionally known cemented lens.

FIG. 4 is an enlarged schematic cross-sectional view illustrating an edge face of a conventionally known cemented lens having a chamfered part.

FIG. 5 is an enlarged schematic view illustrating an edge face of a conventionally known cemented lens having no chamfered part.

FIG. 6 is a schematic cross-sectional view illustrating a cemented lens of the present invention.

FIG. 7 is an enlarged schematic cross-sectional view illustrating the edge face of a cemented lens having a chamfered part and a round part.

FIG. 8A is an enlarged schematic cross-sectional view illustrating the length of a chamfered part having an angled part.

FIG. 8B is an enlarged schematic cross-sectional view illustrating the length of a chamfered part having a round part.

FIG. 9 is a schematic cross-sectional view illustrating an image pickup apparatus in a state with a lens unit (optical system) mounted on an image pickup unit.

FIG. 10 is a schematic view illustrating a measurement method of the internal reflectance.

FIG. 11 is a schematic cross-sectional view illustrating a test piece for evaluating the thermal shock resistance.

FIG. 12 is an enlarged view of the edge face of a test piece for evaluating the thermal shock resistance.

### DESCRIPTION OF THE EMBODIMENTS

In view of such background art, the present invention provides an optical unit including a cemented lens having a chamfered part to which a stress tends to be applied, with a light-shielding film formed on the edge face, which suppresses occurrence of cracking of the lens even under severe thermal shock, having high cleaning resistance and high performance to prevent internal reflection; an optical apparatus and an image pickup apparatus having the optical unit; a light-shielding film formed on the optical unit; and a light-shielding coating material.

The cemented lens having a chamfered part described in Japanese Patent Application Laid-Open No. 2020-024331 allows a light-shielding film to be accumulated in a groove, due to the presence of the chamfered part. The resin content of the light-shielding film in Japanese Patent Application Laid-Open No. 2020-024331 is unknown, so that a stress may occur in the lens under large thermal shock, resulting in peeling of a light-shielding film, cracking or breakage of a lens.

In Japanese Patent Application Laid-Open No. 2013-100456, although an example of the light-shielding film with a large content of resin is described, the concept of a cemented lens is not described and no chamfered part is described. In the case of having no chamfered part, chipping of a lens may occur. Further, the occurrence of stress due to accumulation of the light-shielding film in a chamfered part is not supposed therein.

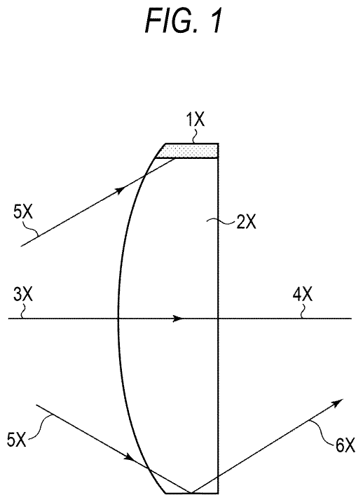

First, the role of the light-shielding film for optical units are described with reference to drawings. FIG. 1 is a schematic view illustrating a conventionally known light-shielding film, and a lens having the light-shielding film. As shown in FIG. 1, the light-shielding film 1X is formed on an optional outer circumferential part of a lens 2X. Among the light incident to the lens 2X, light that does not hit the outer circumferential part of the lens 2X (incident light 3X) is transmitted through as transmitted light 4X. On the other hand, among the light incident to the lens 2X, light that hits the outer circumferential part of the lens 2X (incident light 5X) also hits the light-shielding film 1X disposed on the outer circumferential part of the lens 2X.

In the case where no light-shielding film 1X in FIG. 1 is formed, the light that hits the outer circumferential part of the lens 2X internally reflects and goes out of the lens 2X, as internally reflected light 6X irrelevant to the image. The internally reflected light 6X causes flares, ghosts, etc. which are elements to degrade the image. Accordingly, in order to prevent occurrence of flares, ghosts, etc., disposition of the light-shielding film 1X on the outer circumference of the lens 2X is required. The deposition of the light-shielding film 1X reduces the internally reflected light 6X having negative impact on the image, so that occurrence of flares and ghosts can be prevented.

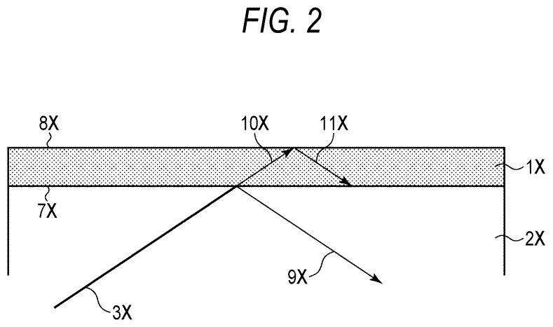

With reference to drawings, the principle of internal reflection is described in detail. FIG. 2 is a schematic view illustrating the traveling direction of the internally reflected light. Incidentally, in FIG. 2, an aspect in which the light-shielding film 1X is applied to the outer circumferential surface of the lens 2X is illustrated. As shown in FIG. 2, the internal reflections of the incident light 3X passing through the lens 2X occur mainly on two interfaces i.e. an interface 7X and an interface 8X between the light-shielding film 1X and air. In other words, the incident light 3X passing through the lens 2X hits an interface 7X to separate into light that is reflected on the interface 7X (first reflected light 9X) and light that is transmitted through the light-shielding film 1X (transmitted light 10X). Further, the transmitted light 10X is reflected at the interface 8X. On this occasion, the reflected light becomes second reflected light 11X. The first reflected light 9X can be reduced by bringing the refractive index of the light-shielding film 1X closer to the refractive index of the lens 2X, or by making the refractive index of the light-shielding film 1X higher than the refractive index of the lens 2X. Along with making higher refractive index of glass, the light-shielding film is also required to have higher refractive index. The second reflected light 11X can be reduced by absorbing the transmitted light 10X. In order to effectively absorb the transmitted light 10X into the inner part of light-shielding film, a colorant or the like may be used.

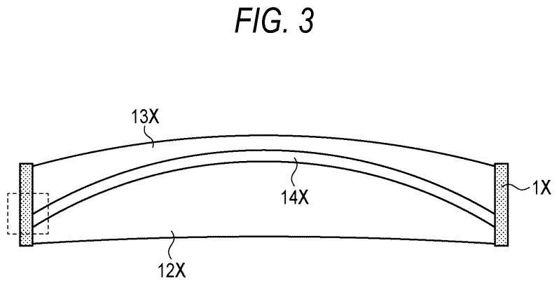

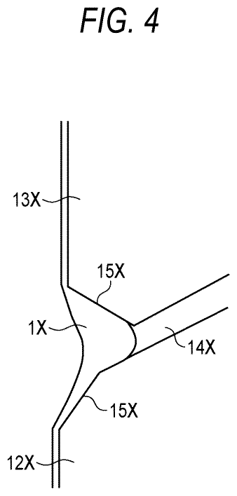

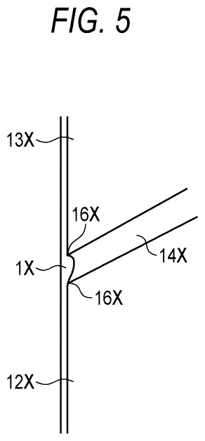

In recent years, a stress tends to be applied to a lens due to formation of a light-shielding film on the outer circumferential part of the lens along with thinning of the laminated part of a cemented lens having difference in linear expansion coefficient, thinning of edge face of a lens, and increased use of soft glass. The cemented lens is described with reference to drawings. FIG. 3 is a schematic cross-sectional view illustrating a conventionally known cemented lens. FIG. 4 and FIG. 5 are enlarged view illustrating the broken line part in FIG. 3. FIG. 4 is an enlarged schematic cross-sectional view illustrating an edge face of a cemented lens having a chamfered part. FIG. 5 is an enlarged schematic view illustrating an edge face of a cemented lens having no chamfered part. The cemented lens includes a first optical element 12X, a second optical element 13X, a third optical element 14X disposed between the first optical element 12X and the second optical element 13X to be joined, and a light-shielding film 1X formed on the edge face of the first optical element 12X, the second optical element 13X and the third optical element 14X. Incidentally, the convex-concave relationship between the first optical element 12X and the second optical element 13X may be inversed in some cases. In many cases, a cemented lens has a chamfered part 15X on the joint surface side in order to prevent cracking due to collision between lenses as shown in FIG. 4. In the case where a chamfered part 15X is present, the light-shielding film 1X is accumulated in the groove part of the chamfered part 15X. In the case where no chamfered part is present as shown in FIG. 5, an angled part 16X having no chamfered part of the first optical element 12X and an angled part 16X having no chamfered part of the second optical element 13X collide each other to easily cause defects such as chipping of a lens. Accordingly, a cemented lens is provided with a chamfered part 15X as in FIG. 4.

Recently, an optical unit is frequently used in a cold district or a scorching circumstances where a large thermal shock may be applied. Accordingly, reduction in the stress to a lens applied by the light-shielding film is required. In the cemented lens having a chamfered part in FIG. 4, the light-shielding film 1X tends to be accumulated in the chamfered part 15X, so that when a large thermal shock is applied, a stress is applied to the first optical element 12X and the second optical element 13X, which may cause peeling of the light-shielding film and cracking or breakage of the optical element.

Further, in order to remove extremely fine dirt attached to a lens in a production process, the lens is required to be cleaned with ultrasonic waves several times after formation of the light-shielding film. The light-shielding film is required not to be peeled off at the interface with the lens by oscillation caused by ultrasonic waves during cleaning.

In the following, the preferred embodiment of the present invention is described.

First, specific means to make an optical unit including a cemented lens having a chamfered part to which stress is easily applied, with an edge face having a light-shielding film, the lens causing no breakage even under severe thermal shock and having high cleaning resistance are described. In addition, an optical apparatus and an image pickup apparatus having the same are described, and further, a light-shielding coating material and a light-shielding film of the present invention are described.

### [Materials to Obtain Light-Shielding Film Having High Thermal Shock Resistance, High Cleaning Resistance, and High Performance to Prevent Internal Reflection]

In order to suppress internal reflection, the light-shielding film is required to have a refractive index equal to or more than the refractive index of the lens. In order to greatly improve the refractive index, it is required to add a large amount of high-refractive inorganic particles to be nano-dispersed in a resin. However, since inorganic particles have a large elastic modulus, addition of a large amount of inorganic particles make a film itself to be hardened, which applies a large stress to the lens, so that the thermal shock resistance is worsened. Further, addition of a large amount of inorganic particles lowers adhesion force, so that the cleaning resistance is worsened.

In order to improve the thermal shock resistance, addition of a flexible resin is presumed. However, the addition thereof lowers adhesion force of the light-shielding film to worsen the cleaning resistance, though the thermal shock resistance is improved.

In order to improve the cleaning resistance, increase in the adhesion force of the light-shielding film and increase in the elastic modulus of the resin are required. However, a high elastic modulus of the resin worsens the thermal shock resistance.

As described above, compatibility among the thermal shock resistance, cleaning resistance and performance to prevent internal reflection is hardly achieved due to contradiction to each other.

Through extensive study on the method for achieving compatibility among the high thermal shock resistance, high cleaning resistance and high performance to prevent internal reflection of an optical unit having the joined edge face of a chamfered lens, the present inventor has found that the compatibility can be achieved by controlling the resin ratio of a light-shielding film containing at least a resin and inorganic particles to 87 vol % or more and 95 vol % or less.

In other words, the optical unit of the present invention comprises a first optical element, a second optical element, a third optical element that joins the first optical element to the second optical element, and a light-shielding film containing a resin and inorganic particles, disposed in contact with edge faces of the first optical element, the second optical element and the third optical element, wherein the first optical element and/or the second optical element has a chamfered part on the joint surface side, wherein at least one of the first optical element and/or the second optical element having the chamfered part has a round part on the joint surface side, and wherein a resin ratio in the light-shielding film is 87 vol % or more and 95 vol % or less.

With a resin ratio of less than 87 vol %, the performance to prevent internal reflection is improved, while the thermal shock resistance and the cleaning resistance are worsened. With a resin ratio of more than 95 vol %, the thermal shock resistance and the cleaning resistance are improved, while the performance to prevent internal reflection is worsened. Accordingly, a cemented lens having a chamfered part with a resin ratio controlled to 87 vol % or more and 95 vol % or less can achieve compatibility among the high thermal shock resistance, high cleaning resistance and high performance to prevent internal reflection.

### [Optical Unit]

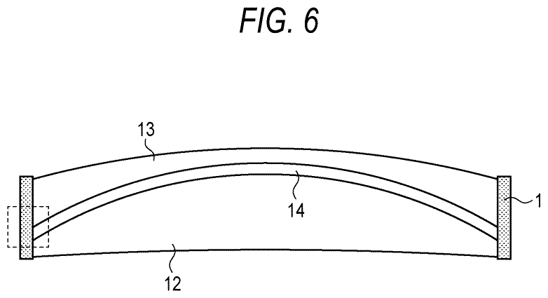

In FIG. 6, a cemented lens as an example of the optical unit of the present invention is shown. The cemented lens of the present invention includes a first optical element 12, a second optical element 13, a third optical element 14 disposed between the first optical element 12 and the second optical element 13 to be joined, and a light-shielding film 1 formed on the edge faces of the first optical element 12, the second optical element 13 and the third optical element 14. The optical unit of the present invention is used, for example, in an optical apparatus such as a camera, video equipment and a lens barrel of broadcasting equipment, and in an image pickup apparatus such as a camera body, video equipment body, monitoring camera, vehicle-mounted camera, and weather camera which may be used outdoors. The optical unit of the present invention has the light-shielding film of the present invention on the surface of a substrate such as glass and plastics. The light-shielding film may be formed on the entire outer circumferential part of the substrate, or may be formed on a part of the outer circumferential part of the substrate. The light-shielding film of the present invention has a first part in contact with the first optical element, a second part in contact with the second optical element, and a third part in contact with the third optical element. The maximum thickness of the third part is preferably thicker than the maximum thickness of each of the first part and the second part. The performance to prevent internal reflection and the thermal shock resistance of the optical unit are thus improved. It is preferable that in the optical unit, the side face of the third part be dented from the first part and the second part. The chipping of the lens of the optical unit can be thus prevented.

The substrate of the lens or the like may be used in any shape. For example, the substrate may be in a convex shape, concave shape or in a combination thereof. The outer circumferential part may be flat, or may have a plurality of steps or grooves. Alternatively, substrates of a plurality of lenses or the like may be bonded together. The outer circumferential part of a lens may have a linear part. As the constituent component of the substrate of a lens or the like, any material may be used. Examples thereof include Li₂O, Na₂O, K₂O, MgO, CaO, SrO, BaO, ZnO, Y₂O₃, La₂O₃, Nd₂O₃, Gd₂O₃, B₂O₃, Al₂O₃, TiO₂, ZrO₂, HfO₂, SiO₂, GeO, Nb₂O₅, Ta₂O₅, P₂O₅, Sb₂O₃, WO₃ and F₂. The constituent component may include one material or may include a plurality of materials in combination.

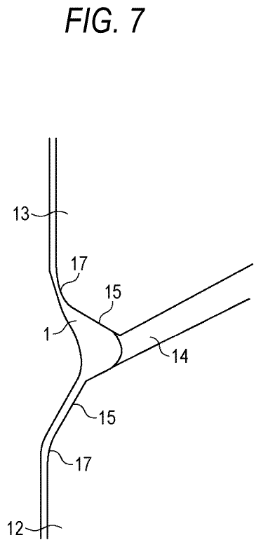

The round part of the optical unit of the present invention is described with reference to FIG. 7. FIG. 7 is an enlarged view of the broken line part in FIG. 6, i.e. an enlarged schematic cross-sectional view illustrating the edge face of a cemented lens having a chamfered part and a round part. It is preferable that in the optical unit of the present invention have a round part 17 on the joint surface side of the chamfered part 15 of the first optical element 12 and/or the second optical element 13 as shown in FIG. 7. Due to having the round part 17, when the light-shielding film 1 is formed, the light-shielding film easily flows out with its own weight, so that the light-shielding film 1 is hardly accumulated in the groove of the chamfered part. Since the light-shielding film 1 is hardly accumulated in the groove of the chamfered part, stress hardly occurs even under thermal shock, so that the thermal shock resistance is improved. The curvature radius of the round part 17 of the present invention is preferably 0.05 mm or more and 1.0 mm or less, more preferably 0.06 mm or more and 0.5 mm or less. With a curvature radius of less than 0.05 mm, the light-shielding coating material hardly flows out during formation of the light-shielding film, so that the film thickness increases, which may worsen the thermal shock resistance. With a curvature radius of more than 1.0 mm, production may be difficult.

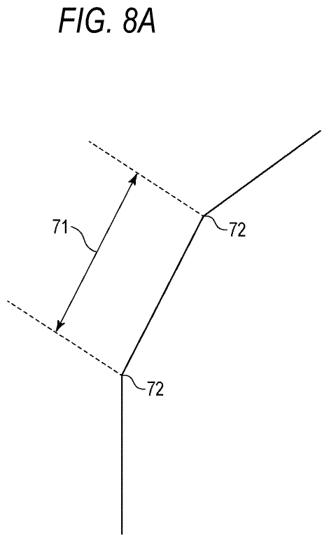

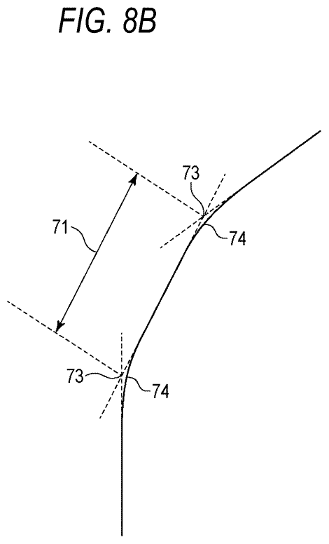

The length of the chamfered part of the optical unit of the present invention is preferably 0.05 mm or more and 0.35 mm or less, more preferably 0.1 mm or more and 0.35 mm or less. With a length of the chamfered part of less than 0.05 mm, defects such as chipping of a lens may occur due to collisions during lens processing. With a length of the chamfered part of more than 0.4 mm, the light-shielding film is easily accumulated in the chamfered part, so that the thermal shock resistance may be worsened due to increased thickness of the light-shielding film. In the case where there exist angled parts 72 as shown in FIG. 8A, the length of the chamfered part is a length 71 from an angled part 72 to an angled part 72. In the case where there exist round parts 74 in the chamfered part as shown in FIG. 8B, the length of the chamfered part is a length 71 from a vertex 73 to a vertex 73 as intersecting point of straight lines each.

The edge face in the present invention is referred to a chamfered part and a round part of the first optical element, an edge part of the second optical element (including a chamfered part and/or a round part in some cases), and an edge part of the exposed surface of the third optical element (refer to FIG. 6 and FIG. 7). Usually, the edge face is the outer circumferential face of a cemented lens.

The maximum diameter of the optical unit of the present invention is preferably 45 mm or more and 300 mm or less, more preferably 45 mm or more and 100 mm or less. A cemented lens having an optical unit with a maximum diameter of less than 45 mm may be hardly produced due to the too small size. A cemented lens having an optical unit with a maximum diameter of more than 300 mm allows a stress to occur in the lens, so that the thermal shock resistance may be worsened.

The difference in linear expansion coefficient between the first optical element of the present invention and the second optical element of the present invention is preferably 5 ppm or more and 20 ppm or less, more preferably 5 ppm or more and 13 ppm or less, at −30° C. to 70° C. A difference in linear expansion coefficient between the first optical element and the second optical element of the present invention of less than 5 ppm is substantially difficult to be achieved. With a difference in linear expansion coefficient between the first optical element and the second optical element of the present invention of more than 20 ppm, stress occurs in the lens, so that the thermal shock resistance may be worsened. Incidentally, all the linear expansion coefficients are represented by numerical values at −30° C. to 70° C., and ppm represents 10⁻⁷/° C.

Examples of the commercially available glass for use as substrate include S-LAM2 (7.4 ppm), S-LAM60 (5.4 ppm), S-TIH53 (8.8 ppm), S-BSL 7 (7.2 ppm), S-NBM51 (6.5 ppm), L-BAL42 (7.2 ppm), S-FPL55 (13.6 ppm), S-FPL51 (13.1 ppm), S-FPM3 (11.5 ppm), S-FSL 5 (9 ppm), S-FPL53 (14.5 ppm), S-FPM4 (12.4 ppm), S-NSL36 (8 ppm), and S-TIL6 (8.2 ppm), all of which are manufactured by OHARA Inc., and quartz (0.5 ppm). Alternatively, equivalent products available from SCHOTT AG, HOYA Corporation, etc. may be used.

The third optical element 14 is a layer of cured adhesive which is a precursor for use in bonding of lenses of glass. The adhesive is required to be optically transparent and to have a high adhesive force and a high curing rate. Acrylic-based, epoxy-based and polyene/polythiol-based curing adhesives are preferably used. To these adhesives, a curing initiator is added so that these adhesives can be cured by heat or UV. However, curing by heat may cause peeling at interface or deformation of a plane shape. Accordingly, the adhesive as the third optical element 14 is preferably a UV curing type. Also, from the viewpoints of lowering the cure shrinkage of the adhesive and adjustment of optical characteristics, it is preferable that inorganic fine particles or the like are mixed and dispersed in the adhesive for use. Further, the maximum film thickness of the light-shielding film in contact with the third optical element is preferably 20 μm or more and 180 μm or less.

An antireflection film (not shown in drawing) may be disposed on the first optical element 12 and the second optical element 13.

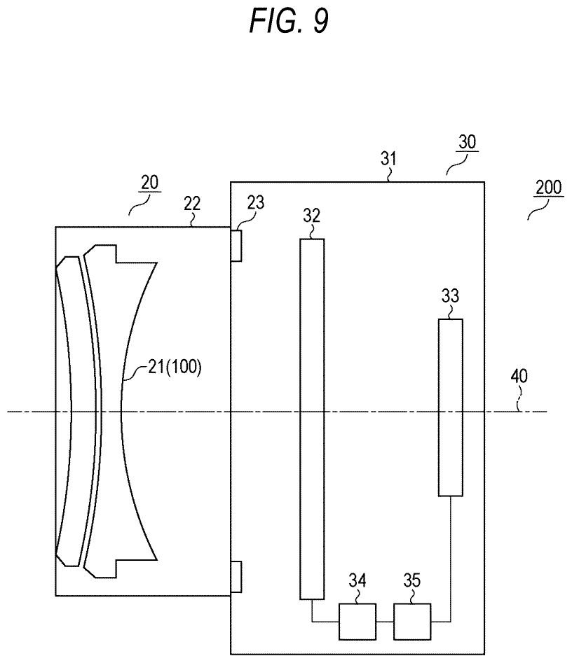

The cemented lens is used as an optical system of optical apparatuses such as image pickup apparatuses (including cameras and video equipments), telescopes, binoculars, copying machines, and projectors, or as a part of the optical system. As an example, a schematic cross-sectional view illustrating an image pickup apparatus 200 in a state with a lens unit (optical system having a plurality of lenses) 20 mounted on an image pickup unit 30 is shown in FIG. 9. A cemented lens 21 (100) is disposed in a housing cylinder 22 of a lens unit 20, and fixed to the image pickup unit 30 with a mount 23. The image pickup unit 30 includes an image pickup element 33 that receives light transmitted through the lens unit 20 and a shutter 32 in a casing. An image pickup element 33 is disposed such that the optical axis 40 of the cemented lens 21 passes through the center thereof. The image pickup unit 30 further includes a driving part 34 that opens and closes a shutter 32, and a control part 35 that controls the driving part 34 and retrieving data from the image pickup element 33.

### [Light-Shielding Coating Material of the Present Invention]

The material constitution of the light-shielding coating material of the present invention and the production method of the light-shielding coating material of the present invention are described as follows.

### <<Material Constitution>>

### (Main Agent)

The main agent contained in the light-shielding coating material of the present invention is described.

As the main agent contained in the light-shielding coating material of the present invention, any material from which a light-shielding film can be formed can be used. Examples of the main agent contained in the light-shielding coating material of the present invention include an epoxy resin, acrylic resin, urethane resin, acrylic urethane resin, phenol resin, melamine resin, polyester resin, alkyd resin and polyimide.

The amount of the main agent added in the light-shielding coating material of the present invention is preferably 5 wt % or more and 87 wt % or less, more preferably 50 wt % or more and 85 wt % or less. With a content of the main agent in the light-shielding coating material of the present invention of less than 5 wt %, the light-shielding film is hardened too much, so that cracking of film may be caused by thermal shock. With a content of the main agent of the present invention of more than 87 wt %, the refractive index of the film may be hardly increased. Incidentally, all the description of wt % is relative to a solid content excluding volatile components.

### (Colorant)

The colorant contained in the light-shielding coating material of the present invention is described.

As the colorant contained in the light-shielding coating material of the present invention, any material that can cause coloring may be used. Examples of the colorant contained in the light-shielding coating material of the present invention include a dye and a pigment, which may be used alone, or a plurality thereof may be mixed for use.

Examples of the dye include an azo dye, quinone-based dye, cyanine-based dye, cation-based dye, merocyanine-based dye, indigo-based dye, and fulgide-based dye. Any color tone may be used, and examples thereof include a black type, brown type, yellow type, red type, blue type, and green type, which may be used alone, or may be mixed for use.

Examples of the pigment include carbon black, titanium black, zirconium nitride, iron oxide, copper-iron-manganese composite oxide, and iron-chromium. The pigment contained in the light-shielding coating material of the present invention may be in any form. Examples of the form of the pigment contained in the light-shielding coating material of the present invention include a spherical form, amorphous form, tabular form, needle form, star form, chain form, and a multi-layered structure with tabular particles stacked. The pigment contained in the light-shielding coating material of the present invention may be coated with another material. The pigment contained in the light-shielding coating material of the present invention has an average particle size of preferably 1 nm or more and 200 nm or less, more preferably 5 nm or more and 50 nm or less. With an average particle size of the pigment contained in the light-shielding coating material of the present invention of less than 1 nm, the coating material may be thickened. With an average particle size of the pigment of the present invention of more than 200 nm, scattering of the film may increase.

The amount of the colorant added in the light-shielding coating material of the present invention is preferably 1 wt % or more and 30 wt % or less, more preferably 2 wt % or more and 20 wt % or less. With an amount of the colorant added in the light-shielding coating material of the present invention of less than 1 wt %, the light incident to the film may not absorbed enough, so that the internal reflection characteristics may be worsened. With an amount of the colorant added in the light-shielding coating material of the present invention of more than 30 wt %, the film may be too hardened. Incidentally, all the description of wt % is relative to a solid content excluding volatile components.

The light-shielding coating material of the present invention is in black color. The black color has a brightness (L*) of less than 14. The brightness of the light-shielding coating material is preferably 10 or less, more preferably 5 or less.

### (Inorganic Particle)

The inorganic particles contained in the light-shielding coating material of the present invention are described.

The average particle size of the inorganic particles contained in the light-shielding coating material of the present invention is preferably 2 nm or more and 250 nm or less, more preferably 50 nm or more and 200 nm or less, and still more preferably 100 nm or more and 180 nm or less. With an average particle size of the inorganic particles of the present invention of more than 200 nm, the scattering of the light-shielding film is increased and the appearance may be worsened.

The d-line refractive index of the inorganic particles contained in the light-shielding coating material of the present invention is preferably 1.6 or more and 3.1 or less, and more preferably 2.0 or more and 3.1 or less. With a d-line refractive index of less than 1.6, addition of a large amount of particles is required to increase the refractive index of the light-shielding film of the present invention, so that the elastic modulus of the light-shielding film increases, which may worsen the thermal shock resistance.

The amount of the inorganic particles added in the light-shielding coating material of the present invention is preferably 2 wt % or more and 60 wt % or less, more preferably in the range of 5 wt % or more and 30 wt % or less. With an amount of the inorganic particles added in the light-shielding coating material of the present invention of less than 2 wt %, the refractive index of the light-shielding film is insufficiently increased, so that the performance to prevent internal reflection may be worsened. With an amount of the inorganic particles added in the light-shielding coating material of the present invention of more than 60 wt %, the elastic modulus of the light-shielding film of the present invention may increase too much, so that the thermal shock resistance may not be improved. Incidentally, all the description of wt % is relative to a solid content excluding volatile components.

As the type of the inorganic particles contained in the light-shielding coating material of the present invention, any optional metal or metal oxide having a d-line refractive index of 1.6 or more and 3.1 or less may be used. Examples of the inorganic particles having a d-line refractive index of 1.60 or more contained in the light-shielding coating material of the present invention include Bengala (3.01), magnetite (2.42), rutile-type titanium oxide (2.72), anatase-type titanium oxide (2.52), zirconium oxide (2.05), cerium oxide (2.2), zinc oxide (2.1), tantalum pentoxide (2.16), aluminum nitride (1.9 to 2.2), tungsten oxide (2.2), niobium pentoxide (2.33), indium tin oxide (2.06), chromium oxide (2.24), diamond (2.42), aluminum oxide (1.63), cerium fluoride (1.63), yttrium oxide (1.87), magnesium oxide (1.74), hafnium oxide (1.95), lanthanum oxide (1.84), scandium oxide (1.89), europium oxide (1.90), molybdenum oxide (1.90), samarium fluoride (1.90), praseodymium oxide (1.92), silicon (3.4), and copper-iron-manganese composite oxide.

The inorganic particles having a d-line refractive index of 1.6 or more contained in the light-shielding coating material of the present invention may be used alone, or a two or more types thereof may be included. Alternatively, the inorganic particles may be a complex thereof.

The inorganic particles contained in the light-shielding coating material of the present invention may be in any form. Examples of the form of the inorganic particles contained in the light-shielding coating material of the present invention include a spherical form, amorphous form, tabular form, needle form, star form, chain form, and a multi-layered structure with tabular particles stacked. The inorganic particles of the present invention may be coated with another material. One type of the inorganic particles contained in the light-shielding coating material of the present invention may be used alone, or a plurality of types may be contained.

### (Curing Agent)

The curing agent contained in the light-shielding coating material of the present invention is described. The curing agent contained in the light-shielding coating material of the present invention may be any material that reacts with a main agent to cause curing. Examples thereof include an amine-based curing agent, an isocyanate-based curing agent, and a photo-initiator. The amount of the curing agent of the present invention added is preferably 1 wt % or more and 50 wt % or less, more preferably 5 wt % or more and 40 wt % or less. With an amount of the curing agent of the present invention added of less than 1 wt %, the curability is worsened, so that cleaning resistance may be worsened. With an amount of the curing agent added in the light-shielding coating material of the present invention of more than 50 wt %, the internal reflection characteristics may be worsened. Incidentally, all the description of wt % is relative to a solid content excluding volatile components.

### (Solvent)

Next, the solvent contained in the light-shielding coating material of the present invention is described.

As the solvent, any optional material may be used. In the case where the light-shielding material has sufficiently low viscosity and can be used as it is, addition of the solvent is not required. Examples of the solvent include water, thinner, ethanol, isopropyl alcohol, n-butyl alcohol, ethyl acetate, propyl acetate, isobutyl acetate, butyl acetate, methyl ethyl ketone, methyl isobutyl ketone, propylene glycol monomethyl ether, propylene glycol monomethyl ether acetate, toluene, xylene, acetone, cellosolves, glycol ethers, ether, hexane, cyclohexane, 1-butanol, methylcyclohexane, ethylcyclohexane, iso-hexane, benzyl alcohol, 2-ethyl-1-hexanol, butylcellosolve, 1-buthoxy-2-propanol, neopentane, Solvesso, trichloroethylene, perchloroethylene, methanol, cellosolve acetate, mineral spirit, tetrahydrofuran, dioxane, N-methyl-2-pyrorridone, ethyl lactate. One type of the solvent may be used alone, or a plurality of types may be contained.

The viscosity of the light-shielding coating material of the present invention is preferably 10 mPa·s or more and 10000 mPa·s or less, more preferably 30 mPa·s or more and 500 mPa·s or less. With a viscosity of the light-shielding coating material of less than 10 mPa·s, a spot having a thin film thickness after application may occur. With a viscosity of the light-shielding coating material of more than 10000 mPa·s, the coatability of the light-shielding coating material may be lowered.

### (Resin and Resin Ratio)

The resin contained in the light-shielding coating material of the present invention and the resin ratio are described. The resin refers to the total of the main agent, curing agent, coupling agent and dispersant, which are materials excluding volatile components, inorganic particles and colorants. The resin ratio refers to the ratio of the total of resins excluding inorganic particles and colorants relative to the solid content. The resin ratio of the light-shielding coating material of the present invention is 70 wt % or more and 84 wt % or less. With a resin ratio of the light-shielding coating material of the present invention of less than 70 wt %, the thermal shock resistance and the cleaning resistance are worsened. With a resin ratio of the light-shielding coating material of the present invention of more than 84 wt %, the refractive index of the film is hardly increased, so that the internal reflection characteristics are worsened. The resin ratio may be determined by dividing the weight loss of film during baking the film at 1000° C. by the weight before baking.

$$Resin ratio ( wt \% ) = Weight loss of film ( g ) / Weight before baking ( g ) \times 100 \qquad ( Formula 1 )$$

### (Other Additives)

The light-shielding coating material of the present invention may contain any other optional additives. Examples thereof include a curing accelerator, dispersant, defoaming agent, thixotropy imparting agent, levelling agent, matting agent, preservative, antibacterial agent, antifungal agent, UV absorber, UV initiator, antioxidant, coupling agent, and inorganic particles and organic fine particles for controlling the color tone other than the ones described above. The addition is performed in the range not to worsen the characteristics. In the present invention, it is preferable that the light-shielding coating material contain a dispersant of which amine value is higher than the acid value. The difference between the acid value and the amine value is preferably in the range of 1 mgKOH/g or more and 100 mgKOH/g or less, more preferably in the range of 2 mgKOH/g or more and 30 mgKOH/g or less.

### <<Production Method of Coating Materials to be Formed on Upper Face of Optical Apparatus>>

In the following, the production method of the light-shielding coating material of the present invention is described.

As the production method of the light-shielding coating material of the present invention, any optional method may be employed as long as the inorganic particles of the present invention having a d-line refractive index of 2.0 or more and an average particle size of 200 nm or less, and a pigment to be added to the light-shielding coating material, can be dispersed in the light-shielding coating material. Examples of the method include use of a bead mill, ball mill, jet mill, three-roller mill, planetary rotating apparatus, mixer, ultrasonic dispersing machine, and homogenizer.

With a d-line refractive index of 2.0 or more, and an average particle size of more than 200 nm, the appearance may be worsened due to scattering of the film.

### [Light-Shielding Film of the Present Invention]

In the following, the material constitution of the light-shielding film of the present invention and the forming method of the light-shielding film are described.

### <<Material Constitution>>

In the following, the material constitution of the light-shielding film of the present invention is described.

### (Main Agent)

The main agent contained in the light-shielding film of the present invention is described. The main agent for use is the same one described in the item [Light-shielding coating material]. The content of the main agent added to the light-shielding film of the present invention is preferably 5 vol % or more and 97 vol % or less, more preferably 40 vol % or more and 90 vol % or less. With a content of the main agent in the light-shielding film of the present invention of less than 5 vol %, the light-shielding film is hardened too much, so that film cracking may be caused. With a content of the main agent in the light-shielding film of the present invention of more than 97 vol %, the refractive index of the film may be hardly increased.

### (Colorant)

The colorant contained in the light-shielding film of the present invention is described.

The content of the colorant added to the light-shielding film of the present invention is preferably 1 vol % or more and 30 vol % or less, more preferably 2 vol % or more and 20 vol % or less. With a content of the colorant added to the light-shielding film of the present invention of less than 1 vol %, the light incident to the film is insufficiently absorbed, so that the internal reflection characteristics may be worsened. With a content of the colorant added to the light-shielding film of the present invention of more than 30 vol %, the film may be hardened too much.

The light-shielding film of the present invention has a black color and a brightness (L*) of less than 14.

The brightness of the light-shielding film is preferably 10 or less, more preferably 5 or less.

### (Inorganic Particles)

The inorganic particles contained in the light-shielding film of the present invention is described.

The content of the inorganic particles added to the light-shielding film of the present invention is preferably 2 vol % or more and 60 vol % or less, more preferably 3 vol % or more and 30 vol % or less. With a content of the inorganic particles added to the light-shielding film of the present invention of less than 2 vol %, the refractive index of the light-shielding film is insufficiently increased, so that the performance to prevent internal reflection may be lowered. With a content of the inorganic particles added to the light-shielding film of the present invention of more than 60 vol %, the thermal shock resistance may be worsened.

### (Curing Agent)

Next, the curing agent contained in the light-shielding film of the present invention is described. As the curing agent contained in the light-shielding film of the present invention, any optional material that can react with the main agent to cause curing may be used. Examples thereof include an amine-based curing agent, isocyanate-based curing agent, and photo initiator. The content of the curing agent added to the light-shielding film of the present invention is preferably 1 vol % or more and 50 vol % or less, more preferably 10 vol % or more and 40 vol % or less. With a content of the curing agent added to the light-shielding film of the present invention of less than 1 vol %, the curability is worsened and the cleaning resistance may be worsened. With a content of the curing agent added to the light-shielding film of the present invention of more than 50 vol %, the internal reflection characteristics may be worsened.

### (Resin Ratio)

The resin contained in the light-shielding film of the present invention and the resin ratio are described. The resin refers to the total of the main agent, curing agent, coupling agent and dispersant, which are materials excluding volatile components, inorganic particles and colorants. The resin ratio refers to the ratio of the total of resins excluding inorganic particles and colorants relative to the solid content. The resin ratio of the light-shielding film of the present invention needs to be 87 vol % or more and 95 vol % or less. With a resin ratio of the light-shielding film of the present invention of less than 87 vol %, the thermal shock resistance and the cleaning resistance are worsened. With a resin ratio of the light-shielding film of the present invention of more than 95 vol %, the refractive index of the film is hardly increased, so that the internal reflection characteristics are worsened. The resin ratio can be determined from the ratio of the area excluding the inorganic particles and colorant relative to the whole area of the image taken by photographing the cross section of the film with a transmitting electron microscope.

$$Resin ratio ( vol \% ) = Area excluding inorganic particles and colorant ( {cm}^{2} ) / Whole area of image ( {cm}^{2} ) \times 100 \qquad ( Formula 2 )$$

### (Other Additives)

The light-shielding film of the present invention may contain any other optional additives. Examples thereof include a curing accelerator, dispersant, defoaming agent, thixotropy imparting agent, levelling agent, matting agent, preservative, antibacterial agent, antifungal agent, UV absorber, UV initiator, antioxidant, coupling agent, and inorganic particles and organic fine particles for controlling the color tone other than the ones described above. In the present invention, it is preferable the light-shielding film contain a dispersant of which amine value is higher than the acid value. The difference between the acid value and the amine value is preferably in the range of 1 mgKOH/g or more and 100 mgKOH/g or less, more preferably in the range of 2 mgKOH/g or more and 30 mgKOH/g or less.

### (Elastic Modulus of Light-Shielding Film)

In recent years, stress tends to be applied to a lens with a light-shielding film formed on the outer circumferential part of the lens, due to thinning of the bonded part of a cemented lens or the edge face of the lens, and increase in soft glass. Also, a lens is frequently used in a cold district or a scorching circumstances where a large thermal shock may be applied. Accordingly, reduction in the stress to a lens applied by the light-shielding film is required. Incidentally, the temperature in a cold district is presumed to be about −30° C.

Further, in order to remove extremely fine dirt attached to a lens in a production process, the lens is required to be cleaned with ultrasonic waves several times after formation of the light-shielding film. The cleaning with ultrasonic waves is performed at normal temperature, i.e. about 20° C. The light-shielding film is required not to cause peeling at the interface with the lens due to vibration from the ultrasonic waves during cleaning.

From the above, an elastic modulus as physical property of the film to ensure the thermal shock resistance and the cleaning resistance is required.

From the viewpoint of thermal shock resistance of the light-shielding film in a presumed cold district, the elastic modulus at −30° C. is preferably 2500 MPa or more and 5100 MPa or less, more preferably 3000 MPa or more and 4900 MPa or less. With an elastic modulus at −30° C. of the light-shielding film of less than 2500 MPa, the elastic modulus at normal temperature is also lowered, so that the cleaning resistance may be worsened. With a resin ratio of the light-shielding film controlled to 87 vol % or more and 95 vol % or less, the elastic modulus in the preferred range is achieved. With an elastic modulus at −30° C. of the light-shielding film of more than 5100 MPa, the lens may be cracked in a thermal shock test.

Under presumption that cleaning is performed at normal temperature, i.e. about 20° C., the elastic modulus of the light-shielding film at 20° C. is preferably 500 MPa or more and 3000 MPa or less, more preferably 1000 MPa or more and 2600 MPa or less. With an elastic modulus of the light-shielding film at 20° C. of less than 500 MPa, the cleaning resistance may be worsened. With an elastic modulus of the light-shielding film at 20° C. of more than 3000 MPa, the elastic modulus at −30° C. increases also, so that the lens may be cracked in a thermal shock test.

### <<Method for Forming Light-Shielding Film>>

The light-shielding film of the present invention has an average film thickness of preferably 1 μm or more and 150 μm or less, more preferably 2 μm or more and 30 μm or less, at the edge faces of a first optical element and a second optical element. Further, the film thickness of the light-shielding film at the chamfered part is preferably 1 μm or more and 180 μm or less at most, more preferably 2 μm or more and 100 μm or less. With a film thickness of the light-shielding film at the chamfered part of less than 1 μm, transparency of the light-shielding film occurs, so that the light-shielding performance may be lowered. With a film thickness of the light-shielding film at the chamfered part of more than 180 μm, the stress to the lens increases, so that cracking of the lens may occur under thermal shock. Further, the maximum film thickness of light-shielding film at the part in contact with the third optical element is preferably 20 μm or more and 180 μm or less. With a maximum film thickness of light-shielding film at the part in contact with the third optical element of less than 20 μm, transparency of the light-shielding film occurs, so that the light-shielding performance may be lowered. With a maximum film thickness of light-shielding film at the part in contact with the third optical element of more than 180 μm, the stress to the lens increases, so that the cracking of the lens may occur under thermal shock.

Any optional coating method and curing method may be employed as long as the light-shielding coating material can be uniformly applied.

Examples of the coating method of the light-shielding coating material of the present invention include brush painting, dip coating, spin coating, transcription and ink jetting. The light-shielding film may be a single-layer coating or a multi-layer coating. Further, the glass face may be subjected to dry surface treatment with UV/ozone, plasma or excimer, or may be subjected to wet surface treatment with a coupling agent.

The method for curing the light-shielding film of the present invention may include leaving at room temperature and heating facilitated by any heat. Examples of the curing method by heating include use of a heating furnace or a heater and IR heating. The curing temperature is preferably from room temperature to 200° C., more preferably from room temperature to 150° C. Alternatively, the light-shielding film of the present invention may be UV-cured.

### EXAMPLES

Preferred examples of the present invention are described as follows.

In Examples 1 to 31, various evaluations, preparation of the light-shielding coating material, and making of the light-shielding film were performed by the following methods.

### <Evaluation Method>

### (Measurement Method of Elastic Modulus)

In measurement of the elastic modulus, a viscoelasticity measuring apparatus was used. A light-shielding film was adjusted into sizes of a width of 5 mm, a length of 20 mm, and a thickness of 0.15 mm, dried for 1 day, and baked at 40° C. for 100 hours, so that a sample for measuring elastic modulus was made. The sample for measuring elastic modulus was set on a viscoelasticity measuring apparatus (Rheogel-E4000 (manufactured by UBM Co., Ltd.)) to measure the elastic modulus at −30° C. and 20° C. It is desirable that the elastic modulus at −30° C. is 2500 MPa or more and 5100 MPa or less.

A is a light-shielding film having an elastic modulus at −30° C. of 3000 MPa or more and 4900 MPa or less, which can be said to be a favorable elastic modulus. B is a light-shielding film having an elastic modulus at −30° C. of 2500 MPa or more and less than 3000 MPa, or having an elastic modulus at −30° C. of more than 4900 MPa and 5100 MPa or less, which can be said to be a relatively favorable light-shielding film. C is a light-shielding film having an elastic modulus at −30° C. of more than 5100 MPa, or having an elastic modulus at −30° C. of less than 2500 MPa, which cannot be said to be a favorable light-shielding film.
A: a light-shielding film having an elastic modulus at −30° C. of 3000 MPa or more and 4900 MPa or less.
B: a light-shielding film having an elastic modulus at −30° C. of 2500 MPa or more and less than 3000 MPa, or having an elastic modulus at −30° C. of more than 4900 MPa and 5100 MPa or less.
C: a light-shielding film having an elastic modulus at −30° C. of more than 5100 MPa, or having an elastic modulus at 30° C. of less than 2500 MPa.

### (Measurement Method of Internal Reflectance)

The internal reflectance was measured with a spectrophotometer (U-4100, manufactured by Hitachi High-Tech Corporation). As the sample for measurement, a triangular prism 50 was used. The triangular prism 50 having a shape with a side in a right angle having a length of 30 mm, and a thickness of 10 mm is made of S-LAH53 (nd=1.8, manufactured by OHARA Corporation).

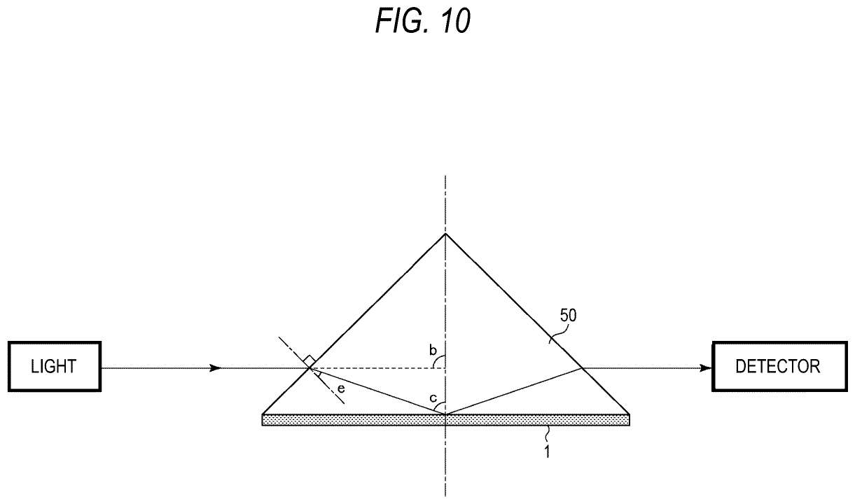

In FIG. 10, a measurement method in the case where the angle of incidence b to a triangular prism 50 is 90° is shown. The light coming out from the spectrophotometer enters the triangular prism 50 at an angle of incidence b=90°. On this occasion, due to the difference in refractive index between air and the triangular prism 50, refraction of light occurs. After refraction, the angle of incidence c=68.13°. The angle e after refraction to the angle of incidence d was calculated by the following formula (3). Further, from an angle e after refraction, the angle of incidence c was calculated.

n=sin d/sin e (Formula 3)

Subsequently, the light refracted at the triangular prism 50 hits the bottom of the triangular prism 50 to be reflected, and then comes out of the triangular prism 50. The intensity of the reflected light in the visible light region with a wavelength range of 400 nm to 700 nm was detected with a detector. As the background, a sample was made of a triangular prism 50 having three mirror surfaces including a bottom, an incidence plane and a reflective surface, with the bottom having no coating. The internal reflectance of a triangular prism 50 having three mirror surfaces including a bottom, an incidence plane and a reflective surface with the bottom having a film, was measured.

In the measurement of internal reflectance, the internal reflection of the visible light in the range of 400 nm to 700 nm was measured at intervals of 1 nm, and the average thereof was described. The internal reflectance was evaluated based on the following criteria. A has an internal reflectance of less than 40%, which can be said to be an excellent film. B has an internal reflection of 40% or more and less than 60%, which can be said to be a film having no problem, though the internal reflection is slightly inferior. C has an internal reflection of 60% or more, which can be said to be a film having poor optical properties.
A: internal reflectance of less than 40%
B: internal reflection of 40% or more and less than 60%
C: internal reflection of 60% or more

### (Evaluation Method of Thermal Shock Resistance)

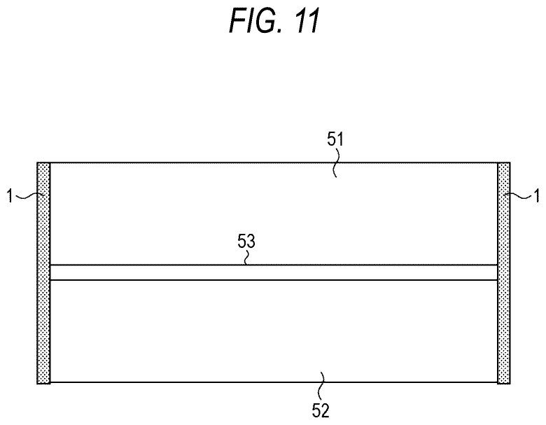

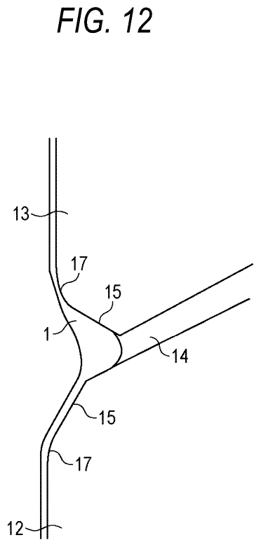

In FIG. 11, a schematic cross-sectional view illustrating a test piece for evaluating the thermal shock resistance is shown. In FIG. 12, an enlarged view of the edge face of a test piece for evaluating the thermal shock resistance is shown. In the evaluation of the thermal shock resistance, as shown in FIG. 11, two sheets of monitor glass i. e., a first circular monitor glass 51 and a second circular monitor glass 52 were bonded together with an adhesive 53. The outer diameter of the first monitor glass and the thickness of the second monitor glass each was 5 mm, and the outer diameter was changed for each of Examples and Comparative Examples. As shown in FIG. 12, a chamfered part 15 and a round part 17 were provided, and the sizes thereof were changed for each of Examples and Comparative Examples. As shown in FIG. 12, the length of the chamfered part 15 of the light-shielding film 1 was changed for each of Examples and Comparative Examples. The thickness of the light-shielding film 1 on the outer circumferential faces of the first monitor glass 51 and the second monitor glass 52 was changed for each of Examples and Comparative Examples. The outer circumferential parts of the first monitor glass 51 and the second monitor glass 52 were ground with #1200. The prepared test piece was left standing in an environment at −50° C. for 30 minutes, and then left standing in an environment at 60° C. for 30 minutes. These procedures constituted one set, and 10 cycles of the sets were performed to apply thermal shock. The thermal shock resistance was evaluated based on the following criteria. A is an optical unit having no problem in thermal shock resistance. B is an optical unit having substantially no problem, with a small change in the light-shielding film. C is an optical unit having a problem in thermal shock resistance, with occurrence of cracking and defects in appearance.
A: no change in light-shielding film and glass.
B: substantially no problem, with a small change in the light-shielding film.
C: occurrence of cracking of light-shielding film and glass and defects in appearance.

### (Evaluation Method of Cleaning Resistance)

For the evaluation of the cleaning resistance, as in the evaluation of the thermal shock resistance, a test piece including a first monitor glass 51 and a second monitor glass 52 shown in FIG. 11 bonded together with an adhesive 53, and a light-shielding film 1 formed on the outer circumferential face thereof with a thickness of about 4 μm, was used.

The test piece thus prepared was subjected to ultrasonic cleaning in water for 5 minutes, and dried. The ultrasonic cleaning was performed 5 times. The cleaning resistance was evaluated based on the following criteria. A is a light-shielding film having no problem, with no peeling and no change in color of internal view of the lens. B is a light-shielding film having substantially no problem, with no peeling and with a small change in color of internal view of the lens. C is a light-shielding film having a problem with peeling.
A: no peeling and no change in color of internal view of the lens.
B: no peeling, with a change in color of internal view of the lens.
C: peeled.

### (Evaluation of Productivity)

For the evaluation of the productivity, as in the evaluation of the thermal shock resistance, a test piece including a first monitor glass 51 and a second monitor glass 52 shown in FIG. 11 bonded together with an adhesive 53, and a light-shielding film 1 formed on the outer circumferential face thereof with a thickness of about 4 μm, was used. One hundred test pieces were prepared, and visually checked whether defects such as cracking occurred in the edge face of the lens. In the case where no piece in 100 test pieces had chipping, the lens was evaluated as an optical unit having high productivity. In the case where one to two pieces in 100 test pieces had chipping, the lens was evaluated as an optical unit having generally high productivity. In the case where three or more pieces in 100 test pieces had chipping, the lens was evaluated as an optical unit having poor productivity.
A: no piece in 100 test pieces had defects such as chipping.
B: one to two pieces in 100 test pieces had chipping.
C: three of more pieces in 100 test pieces had chipping.

### (Evaluation of Color)

For evaluation of color, a test piece including an optional glass substrate with a light-shielding film 1 having a thickness of about 20 μm formed thereon was used. The measurement of color of the test piece prepared was performed by measuring the brightness L* with a color-difference meter. A is a film having L* of less than 5, which can be said to be a film having a high blackness. B is a film having L* of 5 or more and less than 14, which can be said to be black. C is a film having L* of 14 or more, which cannot be said to be in black color.
A: film having a high blackness.
B: film in black color.
C: film not in black color.

### (Measurement Method of Average Particle Size)

The average particle size was measured with a dynamic light scattering apparatus (Zeta sizer Neo MPT-2, manufactured by Sysmex Corporation). Inorganic particles diluted with a solvent were placed in a cell, and an average in 20 times of measurement at 5 mV was detected. The peak value in the number distribution was defined as average particle size. The average particle size was evaluated based on the following criteria. A can be said to be an excellent light-shielding film with few scattering, having an average particle size of 200 nm or less. C cannot be said to be a good light-shielding film with increased scattering, having an average particle size of more than 200 nm.
A: in the case having an average particle size of 200 nm or less.
C: in the case having an average particle of more than 200 nm.

### (Measurement Method of Film Thickness)

The measurement of the film thickness of an optical device was performed as follows. The cut section of a sample for evaluation was polished and subjected to measurement with a field emission scanning electron microscope (ULTRA55, manufactured by Carl Zeiss AG).

The film thickness in Tables 1 to 6 represents the maximum film thickness of the part of a light-shielding film in contact with the third optical element.

### Example 1

### (Preparation of Light-Shielding Film)

In Example 1, a light-shielding coating material was prepared by the following method. First, 300 g of epoxy resin A as main agent, 40 g of colorant A, 200 g of inorganic particles A, 20 g or coupling agent A, 60 g of dispersant, and 400 g of solvent A were weighed. All the weighed raw materials were placed in a container and stirred with a stirring blade for 20 minutes, so that a pre-dispersion was obtained. The pre-dispersion was stirred with a bead mill for 180 minutes, so that a light-shielding coating material in Example 1 was obtained.

As solvent A, toluene was used. As inorganic particles A having a d-line refractive index of 2.0 or more and an average particle size of 200 nm or less, rutile-type titanium oxide was used. As colorant A, carbon black was used. As dispersant A, DISPERBYK2155 (manufactured by BYK Japan K.K.) was used. As epoxy resin A, a bisphenol A-type epoxy resin (jER828, manufactured by Mitsubishi Chemical Corporation) was used.

As coupling agent A, an epoxy-based silane coupling agent (KBM403, manufactured by Shin-Etsu Chemical Co., Ltd.) was used.

As inorganic particles A, the material for use was selected from TTO-51 (A) (Ishihara Sangyo), TTO-51 (C) (Ishihara Sangyo), TTO-55 (A) (Ishihara Sangyo), TTO-55 (B) (Ishihara Sangyo), TTO-55 (C) (Ishihara Sangyo), TTO-55 (D) (Ishihara Sangyo), STR-100N (Sakai Chemical Industry), STR-100A-LP (Sakai Chemical Industry), STR-100C-LP (Sakai Chemical Industry), STR-100W-LP (Sakai Chemical Industry), STR-100C-LF (Sakai Chemical Industry), STR-100W-OTS (Sakai Chemical Industry), STR-100W (G) (Sakai Chemical Industry), STR-40OTS (Sakai Chemical Industry), MT-01 (TAYCA), MT-10EX (TAYCA), MT-05 (TAYCA), MT-100S (TAYCA), MT-100TV (TAYCA), MT-100Z (TAYCA), MT-150EX (TAYCA), MT-150W (TAYCA), MT-100AQ (TAYCA), MT-100WP (TAYCA), MT-100SA (TAYCA), and MT-100HD (TAYCA).

As colorant, the material for use was selected from #2650 (Mitsubishi Chemical), #2600 (Mitsubishi Chemical),
#2350 (Mitsubishi Chemical), #2300 (Mitsubishi Chemical), #1000 (Mitsubishi Chemical), #980 (Mitsubishi Chemical),
#970 (Mitsubishi Chemical), #960 (Mitsubishi Chemical), #950 (Mitsubishi Chemical), #850 (Mitsubishi Chemical),
MCF88 (Mitsubishi Chemical), MA600 (Mitsubishi Chemical), #750B (Mitsubishi Chemical), #650B (Mitsubishi Chemical), and
MA100 (Mitsubishi Chemical), and MA220 (Mitsubishi Chemical).

### (Preparation of Light-Shielding Film)

In Example 1, the light-shielding film was prepared by the following method. To the whole amount of the light-shielding coating material, 180 g of a hardening agent A was added and stirred with a roll coater for 30 minutes. As hardening agent A, an amine-based hardening agent was used.

As amine-based hardening agent, any one of the following was used: ADEKA HARDENER EH-6019 (ADEKA), ADEKA HARDENER EH-6024 (ADEKA), ADEKA HARDENER EH-6028 (ADEKA), ADEKA HARDENER EH-479 (ADEKA), ADEKA HARDENER EH-451N (ADEKA), ADEKA HARDENER EH-4602 (ADEKA), ADEKA HARDENER EH2300 (ADEKA), ADEKA HARDENER EH3427A (ADEKA), ADEKA HARDENER EH4024W (ADEKA), ST1 (Mitsubishi Chemical), ST12 (Mitsubishi Chemical), ST14 (Mitsubishi Chemical), ST15 (Mitsubishi Chemical), H3 (Mitsubishi Chemical), H30 (Mitsubishi Chemical), FL11 (Mitsubishi Chemical), FL11W (Mitsubishi Chemical), and SA1 (Mitsubishi Chemical).

The resulting mixture of the light-shielding coating material and the hardening agent was applied to a glass or lens to be evaluated at a predetermined thickness, and dried at room temperature for 60 minutes. After drying of the film, curing was performed in a constant temperature chamber at 40° C. for 8 hours, so that the film in Example 1 was obtained.

As first monitor glass, S-FPL53 (manufactured by OHARA Inc., linear expansion coefficient: 14.5 ppm) was used.

As second monitor glass, quartz S-FPL53 (manufactured by Toray, linear expansion coefficient: 0.5 ppm) was used.

### (Preparation of Samples for Evaluation of Thermal Shock Resistance, Cleaning Resistance and Productivity)

In preparation of samples for evaluation of thermal shock resistance, cleaning resistance and productivity, S-FPL55 (manufactured by OHARA Inc., linear expansion coefficient: 13.6 ppm) was used as the first monitor glass. The first monitor glass was processed to have an optical unit having a diameter of 65 mm, and to have a first optical element with a chamfer length of 0.3 mm and a round part having a curvature radius of 0.3 mm. Quartz S-FPL53 (manufactured by Toray, linear expansion coefficient: 0.5 ppm) was used as the second monitor glass. The second monitor glass was processed to have an optical unit having a diameter of 65 mm, and to have a second optical element with a chamfer length of 0.3 mm and a round part having a curvature radius of 0.3 mm. As adhesive, UT20V (manufactured by Kaneda) was used and cured with UV rays. Incidentally, the difference in linear expansion coefficient between the first optical element and the second optical element is 14 ppm.

### Example 2 to 31

In Examples 2 to 31, a light-shielding film was prepared in the same manner as in Example 1, except that the materials and conditions were according to the materials and conditions in Tables 1 to 6.

Regarding the main agent, coupling agent, dispersant, solvent and curing agent, the same ones were used in all Examples and Comparative Examples.

As inorganic particles B, iron oxide (TM Red 8270, manufactured by Dainichiseika Color & Chemicals Mfg. Co., Ltd.) was used. As inorganic particles C, zirconia (ZIROSTAR ZP-153, manufactured by Nippon Shokubai Co., Ltd.) was used. As colorant B, a black-based dye (VALIFAST BLACK3810, manufactured by Orient Chemical Industries Co., Ltd.) was used.

As epoxy resin B, DENACOL EX-211 (Nagase ChemteX) was used. As epoxy resin C, DENACOL EX-321L (Nagase ChemteX) was used. As epoxy resin D, DENACOL EX-121 (Nagase ChemteX) was used. As epoxy resin E, jER152 (Mitsubishi Chemical) was used.

TABLE 1

| | | | Example | Example | Example | Example | Example |
|---|---|---|---|---|---|---|---|
| | | | 1 | 2 | 3 | 4 | 5 |
| Shape of | Curvature radius of | | 0.3 | 0.3 | 0.3 | 0 | 0.05 |
| monitor | round part (mm) | | | | | | |
| glass | Chamfer length of first | | 0.3 | 0.3 | 0.3 | 0.3 | 0.3 |
| | optical element (mm) | | | | | | |
| | Diameter of optical | | 65 | 65 | 65 | 65 | 65 |
| | unit (mm) | | | | | | |
| | Difference in linear | | 13 | 13 | 13 | 13 | 13 |
| | expansion coefficient | | | | | | |
| | between first optical | | | | | | |
| | element and second | | | | | | |
| | optical element (ppm) | | | | | | |
| Light- | Resin ratio (vol %) | | 87 | 95 | 89 | 87 | 87 |
| shielding | Resin ratio (wt %) | | 70 | 87 | 74 | 70 | 70 |
| film | Film thickness (μm) | | 60 | 60 | 60 | 90 | 80 |
| | Elastic modulus | | 4000 | 3500 | 3700 | 4000 | 4000 |
| | at −30° C. (Mpa) | | | | | | |
| Light- | Inorganic | Material | Inorganic | Inorganic | Inorganic | Inorganic | Inorganic |
| shielding | particle | | particle A | particle A | particle A | particle A | particle A |
| coating | | Amount | 200 | 200 | 200 | 200 | 200 |
| material | | added | | | | | |
| | Colorant | Material | Colorant A | Colorant A | Colorant A | Colorant A | Colorant A |
| | | Amount | 40 | 40 | 40 | 40 | 40 |
| | | added | | | | | |
| | Dispersant | Material | Dispersant | Dispersant | Dispersant | Dispersant | Dispersant |
| | | | A | A | A | A | A |
| | | Amine | more | more | more | more | more |
| | | value/Acid | than 1 | than 1 | than 1 | than 1 | than 1 |
| | | value | | | | | |
| | | Amount | 60 | 60 | 60 | 60 | 60 |
| | | added | | | | | |
| | Solvent | Material | Solvent A | Solvent A | Solvent A | Solvent A | Solvent A |
| | | Amount | 400 | 400 | 400 | 400 | 400 |
| | | added | | | | | |
| | Main | Material | Epoxy | Epoxy | Epoxy | Epoxy | Epoxy |
| | agent | | resin A | resin A | resin A | resin A | resin A |
| | | Amount | 300 | 950 | 370 | 300 | 300 |
| | | added | | | | | |
| | Coupling | Material | Coupling | Coupling | Coupling | Coupling | Coupling |
| | agent | | agent A | agent A | agent A | agent A | agent A |
| | | Amount | 20 | 20 | 20 | 20 | 20 |
| | | added | | | | | |
| | Curing | Material | Curing | Curing | Curing | Curing | Curing |
| | agent | | agent A | agent A | agent A | agent A | agent A |
| | | Amount | 180 | 550 | 230 | 180 | 180 |
| | | added | | | | | |

TABLE 2

| | | | Example | Example | Example | Example | Example |
|---|---|---|---|---|---|---|---|
| | | | 6 | 7 | 8 | 9 | 10 |
| Shape of | Curvature radius of | | 0.2 | 1 | 1.1 | 0.3 | 0.2 |
| monitor | round part (mm) | | | | | | |
| glass | Chamfer length of first | | 0.3 | 0.3 | 0.3 | 0.05 | 0.35 |
| | optical element (mm) | | | | | | |
| | Diameter of optical | | 65 | 65 | 65 | 65 | 65 |
| | unit (mm) | | | | | | |
| | Difference in linear | | 13 | 13 | 13 | 13 | 13 |
| | expansion coefficient | | | | | | |
| | between first optical | | | | | | |
| | element and second | | | | | | |
| | optical element (ppm) | | | | | | |
| Light- | Resin ratio (vol %) | | 87 | 87 | 87 | 87 | 87 |
| shielding | Resin ratio (wt %) | | 70 | 70 | 70 | 70 | 70 |
| film | Film thickness (μm) | | 60 | 50 | 50 | 20 | 65 |
| | Elastic modulus | | 4000 | 4000 | 4000 | 4000 | 4000 |
| | at −30° C. (Mpa) | | | | | | |
| Light-shielding | Inorganic | Material | Inorganic | Inorganic | Inorganic | Inorganic | Inorganic |
| coating | particle | | particle A | particle A | particle A | particle A | particle A |
| material | | Amount | 200 | 200 | 200 | 200 | 200 |
| | | added | | | | | |
| | Colorant | Material | Colorant A | Colorant A | Colorant A | Colorant A | Colorant A |
| | | Amount | 40 | 40 | 40 | 40 | 40 |
| | | added | | | | | |
| | Dispersant | Material | Dispersant | Dispersant | Dispersant | Dispersant | Dispersant |
| | | | A | A | A | A | A |
| | | Amine | more | more | more | more | more |
| | | value/Acid | than 1 | than 1 | than 1 | than 1 | than 1 |
| | | value | | | | | |
| | | Amount | 60 | 60 | 60 | 60 | 60 |
| | | added | | | | | |
| | Solvent | Material | Solvent A | Solvent A | Solvent A | Solvent A | Solvent A |
| | | Amount | 400 | 400 | 400 | 400 | 400 |
| | | added | | | | | |
| | Main | Material | Epoxy | Epoxy | Epoxy | Epoxy | Epoxy |
| | agent | | resin A | resin A | resin A | resin A | resin A |
| | | Amount | 300 | 300 | 300 | 300 | 300 |
| | | added | | | | | |
| | Coupling | Material | Coupling | Coupling | Coupling | Coupling | Coupling |
| | agent | | agent A | agent A | agent A | agent A | agent A |
| | | Amount | 20 | 20 | 20 | 20 | 20 |
| | | added | | | | | |
| | Curing | Material | Curing | Curing | Curing | Curing | Curing |
| | agent | | agent A | agent A | agent A | agent A | agent A |
| | | Amount | 180 | 180 | 180 | 180 | 180 |
| | | added | | | | | |

TABLE 3

| | | | Example | Example | Example | Example | Example |
|---|---|---|---|---|---|---|---|
| | | | 11 | 12 | 13 | 14 | 15 |
| Shape of | Curvature radius of | | 0.3 | 0.3 | 0.3 | 0.3 | 0.3 |
| monitor | round part (mm) | | | | | | |
| glass | Chamfer length of first | | 0.4 | 0.3 | 0.3 | 0.3 | 0.3 |
| | optical element (mm) | | | | | | |
| | Diameter of optical | | 65 | 5 | 300 | 4 | 310 |
| | unit (mm) | | | | | | |
| | Difference in linear | | 13 | 13 | 13 | 13 | 13 |
| | expansion coefficient | | | | | | |
| | between first optical | | | | | | |
| | element and second | | | | | | |
| | optical element (ppm) | | | | | | |
| Light- | Resin ratio (vol %) | | 87 | 87 | 87 | 87 | 87 |
| shielding | Resin ratio (wt %) | | 70 | 70 | 70 | 70 | 70 |
| film | Film thickness (μm) | | 75 | 60 | 60 | 60 | 60 |
| | Elastic modulus | | 4000 | 4000 | 4000 | 4000 | 4000 |
| | at −30° C. (Mpa) | | | | | | |
| Light-shielding | Inorganic | Material | Inorganic | Inorganic | Inorganic | Inorganic | Inorganic |
| coating | particle | | particle A | particle A | particle A | particle A | particle A |
| material | | Amount | 200 | 200 | 200 | 200 | 200 |
| | | added | | | | | |
| | Colorant | Material | Colorant A | Colorant A | Colorant A | Colorant A | Colorant A |
| | | Amount | 40 | 40 | 40 | 40 | 40 |
| | | added | | | | | |
| | Dispersant | Material | Dispersant | Dispersant | Dispersant | Dispersant | Dispersant |
| | | | A | A | A | A | A |
| | | Amine | more | more | more | more | more |
| | | value/Acid | than 1 | than 1 | than 1 | than 1 | than 1 |
| | | value | | | | | |
| | | Amount | 60 | 60 | 60 | 60 | 60 |
| | | added | | | | | |
| | Solvent | Material | Solvent A | Solvent A | Solvent A | Solvent A | Solvent A |
| | | Amount | 400 | 400 | 400 | 400 | 400 |
| | | added | | | | | |
| | Main | Material | Epoxy | Epoxy | Epoxy | Epoxy | Epoxy |
| | agent | | resin A | resin A | resin A | resin A | resin A |
| | | Amount | 300 | 300 | 300 | 300 | 300 |
| | | added | | | | | |
| | Coupling | Material | Coupling | Coupling | Coupling | Coupling | Coupling |
| | agent | | agent A | agent A | agent A | agent A | agent A |
| | | Amount | 20 | 20 | 20 | 20 | 20 |
| | | added | | | | | |
| | Curing | Material | Curing | Curing | Curing | Curing | Curing |
| | agent | | agent A | agent A | agent A | agent A | agent A |
| | | Amount | 180 | 550 | 230 | 180 | 180 |
| | | added | | | | | |

TABLE 4

| | | | Example | Example | Example | Example | Example |
|---|---|---|---|---|---|---|---|
| | | | 16 | 17 | 18 | 19 | 20 |
| Shape of | Curvature radius of | | 0.3 | 0.3 | 0.3 | 0.3 | 0.3 |
| monitor | round part (mm) | | | | | | |
| glass | Chamfer length of first | | 0.3 | 0.3 | 0.3 | 0.3 | 0.3 |
| | optical element (mm) | | | | | | |
| | Diameter of optical | | 65 | 65 | 65 | 65 | 65 |
| | unit (mm) | | | | | | |
| | Difference in linear | | 5 | 14 | 4 | 0.1 | 14 |
| | expansion coefficient | | | | | | |
| | between first optical | | | | | | |
| | element and second | | | | | | |
| | optical element (ppm) | | | | | | |
| Light- | Resin ratio (vol %) | | 87 | 87 | 87 | 87 | 87 |
| shielding | Resin ratio (wt %) | | 70 | 70 | 70 | 70 | 70 |
| film | Film thickness (μm) | | 60 | 60 | 60 | 60 | 20 |
| | Elastic modulus | | 4000 | 4000 | 4000 | 4000 | 4000 |
| | at −30° C. (Mpa) | | | | | | |
| Light-shielding | Inorganic | Material | Inorganic | Inorganic | Inorganic | Inorganic | Inorganic |
| coating | particle | | particle A | particle A | particle A | particle A | particle A |
| material | | Amount | 200 | 200 | 200 | 200 | 200 |
| | | added | | | | | |
| | Colorant | Material | Colorant A | Colorant A | Colorant A | Colorant A | Colorant A |
| | | Amount | 40 | 40 | 40 | 40 | 40 |
| | | added | | | | | |
| | Dispersant | Material | Dispersant | Dispersant | Dispersant | Dispersant | Dispersant |
| | | | A | A | A | A | A |
| | | Amine | more | more | more | more | more |
| | | value/Acid | than 1 | than 1 | than 1 | than 1 | than 1 |
| | | value | | | | | |
| | | Amount | 60 | 60 | 60 | 60 | 60 |
| | | added | | | | | |
| | Solvent | Material | Solvent A | Solvent A | Solvent A | Solvent A | Solvent A |
| | | Amount | 400 | 400 | 400 | 400 | 400 |
| | | added | | | | | |
| | Main | Material | Epoxy | Epoxy | Epoxy | Epoxy | Epoxy |
| | agent | | resin A | resin A | resin A | resin A | resin A |
| | | Amount | 300 | 300 | 300 | 300 | 300 |
| | | added | | | | | |
| | Coupling | Material | Coupling | Coupling | Coupling | Coupling | Coupling |
| | agent | | agent A | agent A | agent A | agent A | agent A |
| | | Amount | 20 | 20 | 20 | 20 | 20 |
| | | added | | | | | |
| | Curing | Material | Curing | Curing | Curing | Curing | Curing |
| | agent | | agent A | agent A | agent A | agent A | agent A |
| | | Amount | 180 | 550 | 230 | 180 | 180 |
| | | added | | | | | |

TABLE 5

| | | | Example | Example | Example | Example | Example |
|---|---|---|---|---|---|---|---|
| | | | 21 | 22 | 23 | 24 | 25 |
| Shape of | Curvature radius of | | 0.3 | 0.3 | 0.3 | 0.3 | 0.3 |
| monitor | round part (mm) | | | | | | |
| glass | Chamfer length of first | | 0.3 | 0.3 | 0.3 | 0.3 | 0.3 |
| | optical element (mm) | | | | | | |
| | Diameter of optical | | 65 | 65 | 65 | 65 | 65 |
| | unit (mm) | | | | | | |
| | Difference in linear | | 13 | 13 | 13 | 13 | 13 |
| | expansion coefficient | | | | | | |
| | between first optical | | | | | | |
| | element and second | | | | | | |
| | optical element (ppm) | | | | | | |
| Light- | Resin ratio (vol %) | | 87 | 87 | 87 | 87 | 87 |
| shielding | Resin ratio (wt %) | | 70 | 70 | 70 | 70 | 70 |
| film | Film thickness (μm) | | 180 | 18 | 190 | 60 | 60 |
| | Elastic modulus | | 4000 | 4000 | 4000 | 3000 | 4900 |
| | at −30° C. (Mpa) | | | | | | |
| Light-shielding | Inorganic | Material | Inorganic | Inorganic | Inorganic | Inorganic | Inorganic |
| coating | particle | | particle A | particle A | particle A | particle A | particle A |
| material | | Amount | 200 | 200 | 200 | 200 | 200 |
| | | added | | | | | |
| | Colorant | Material | Colorant | Colorant | Colorant | Colorant | Colorant |
| | | | A | A | A | A | A |
| | | Amount | 40 | 40 | 40 | 40 | 40 |
| | | added | | | | | |
| | Dispersant | Material | Dispersant | Dispersant | Dispersant | Dispersant | Dispersant |
| | | | A | A | A | A | A |
| | | Amine | more | more | more | more | more |
| | | value/Acid | than 1 | than 1 | than 1 | than 1 | than 1 |
| | | value | | | | | |
| | | Amount | 60 | 60 | 60 | 60 | 60 |
| | | added | | | | | |
| | Solvent | Material | Solvent A | Solvent A | Solvent A | Solvent A | Solvent A |
| | | Amount | 400 | 400 | 400 | 400 | 400 |
| | | added | | | | | |
| | Main | Material | Epoxy | Epoxy | Epoxy | Epoxy | Epoxy |
| | agent | | resin A | resin A | resin A | resin B | resin D |
| | | Amount | 300 | 300 | 300 | 300 | 300 |
| | | added | | | | | |
| | Coupling | Material | Coupling | Coupling | Coupling | Coupling | Coupling |
| | agent | | agent A | agent A | agent A | agent A | agent A |
| | | Amount | 20 | 20 | 20 | 20 | 20 |
| | | added | | | | | |
| | Curing | Material | Curing | Curing | Curing | Curing | Curing |
| | agent | | agent A | agent A | agent A | agent A | agent A |
| | | Amount | 180 | 180 | 180 | 180 | 180 |
| | | added | | | | | |

TABLE 6

| | | | Example | Example | Example | Example | Example | Example |
|---|---|---|---|---|---|---|---|---|
| | | | 26 | 27 | 28 | 29 | 30 | 31 |
| Shape of | Curvature radius of | | 0.3 | 0.3 | 0.3 | 0.3 | 0.3 | 0.3 |
| monitor | round part (mm) | | | | | | | |
| glass | Chamfer length of first | | 0.3 | 0.3 | 0.3 | 0.3 | 0.3 | 0.3 |
| | optical element (mm) | | | | | | | |
| | Diameter of optical | | 65 | 65 | 65 | 65 | 65 | 65 |
| | unit (mm) | | | | | | | |
| | Difference in linear | | 13 | 13 | 13 | 13 | 13 | 13 |
| | expansion coefficient | | | | | | | |
| | between first optical | | | | | | | |
| | element and second | | | | | | | |
| | optical element (ppm) | | | | | | | |
| Light- | Resin ratio (vol %) | | 87 | 87 | 87 | 87 | 87 | 87 |
| shielding | Resin ratio (wt %) | | 70 | 70 | 70 | 70 | 70 | 70 |
| film | Film thickness (μm) | | 60 | 60 | 60 | 60 | 60 | 60 |
| | Elastic modulus | | 2500 | 5100 | 4000 | 4000 | 4000 | 4000 |
| | at −30° C. (Mpa) | | | | | | | |
| Light-shielding | Inorganic | Material | Inorganic | Inorganic | Inorganic | Inorganic | Inorganic | Inorganic |
| coating | particle | | particle A | particle A | particle B | particle C | particle A | particle A |
| material | | Amount | 200 | 200 | 200 | 200 | 200 | 200 |
| | | added | | | | | | |
| | Colorant | Material | Colorant | Colorant | Colorant | Colorant | Colorant | Colorant |
| | | | A | A | A | A | B | A |
| | | Amount | 40 | 40 | 40 | 40 | 40 | 40 |
| | | added | | | | | | |
| | Dispersant | Material | Dispersant | Dispersant | Dispersant | Dispersant | Dispersant | Dispersant |
| | | | A | A | A | A | A | B |
| | | Amine | 1 or | 1 or | 1 or | 1 or | 1 or | 1 or |
| | | value/Acid | more | more | more | more | more | more |
| | | value | | | | | | |
| | | Amount | 60 | 60 | 60 | 60 | 60 | 60 |
| | | added | | | | | | |
| | Solvent | Material | Solvent A | Solvent A | Solvent A | Solvent A | Solvent A | Solvent A |
| | | Amount | 400 | 400 | 400 | 400 | 400 | 400 |
| | | added | | | | | | |
| | Main | Material | Epoxy | Epoxy | Epoxy | Epoxy | Epoxy | Epoxy |
| | agent | | resin D | resin E | resin A | resin A | resin A | resin A |
| | | Amount | 300 | 300 | 300 | 300 | 300 | 300 |
| | | added | | | | | | |
| | Coupling | Material | Coupling | Coupling | Coupling | Coupling | Coupling | Coupling |
| | agent | | agent A | agent A | agent A | agent A | agent A | agent A |
| | | Amount | 20 | 20 | 20 | 20 | 20 | 20 |
| | | added | | | | | | |
| | Curing | Material | Curing | Curing | Curing | Curing | Curing | Curing |
| | agent | | agent A | agent A | agent A | agent A | agent A | agent A |
| | | Amount | 180 | 180 | 180 | 180 | 180 | 180 |
| | | added | | | | | | |

### <Evaluation Results>

By the methods described above, the thermal shock resistance, cleaning resistance, internal reflectance, productivity (defect rate), elastic modulus, color and average particle size of the light-shielding film in the Examples 1 to 31 were evaluated, and the results are shown in Tables 7 to 12.

As the evaluation results, it is preferable that a slight change in the light-shielding film in the thermal shock resistance test be in an allowable range. It is also preferable that no peeling or no color change in the internal view of the lens occur in the cleaning resistance test. It is also preferable that the internal reflectance be less than 60%. In the preferred productivity, the number of test pieces having chipping is within two pieces in 100 test pieces. Regarding elastic modulus, the preferred elastic modulus at −30° C. is 2500 MPa or more and 5100 MPa or less. Regarding color, the preferred L* is less than 14. The average particle size is preferably 200 nm or less.

In Example 1, a light-shielding coating material was made from an epoxy resin, colorant, inorganic particles, coupling agent, dispersant and solvent. The resulting light-shielding coating material and a curing agent were mixed to make a mixture. The mixture was applied to a test piece to form a light-shielding film for each evaluation, and the test piece was subjected to evaluations of thermal shock resistance, cleaning resistance, internal reflectance, productivity, elastic modulus, color or average particle size. As shown in Table 7, no change was found in the thermal shock resistance test, which was good. In the cleaning resistance test, no peeling and no change in color of the internal view of lens were found. The internal reflectance was less than 40%, which was good. The productivity was good without any occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 2, relative to Example 1, a light-shielding film having a resin ratio of 95 vol % was used. As shown in Table 7, no change was found in the thermal shock resistance test, which was good. No peeling and no change in color of the internal view of lens were found in the cleaning resistance test. The internal reflectance was 40% or more and less than 60%, which was mostly good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 3, relative to Example 1, a light-shielding film having a resin ratio of 89 vol % was used. As shown in Table 7, no change was found in the thermal shock resistance test, which was good. No peeling and no change in color of the internal view of lens were found in the cleaning resistance test. The internal reflectance was 40% or more and less than 60%, which was mostly good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 4, relative to Example 1, an optical unit having no round part was used. As shown in Table 7, no change was found in the thermal shock resistance test, which was good. No peeling and no change in color of the internal view of lens were found in the cleaning resistance test. The internal reflectance was less than 40%, which was good. The productivity was in an allowable range though 1 to 2 pieces had occurrence of tiny chipping. Since the elastic modulus was 3000 MPa or more and 4900 MPa or less at −30° C., the film was good.

Regarding the color, since the L* value was less than 5, the film was good. The average particle size was 200 nm or less, which was good.

In Example 5, relative to Example 1, an optical unit having a round part with a curvature radius of 0.05 mm was used.

As shown in Table 7, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 6, relative to Example 1, an optical unit having a round part with a curvature radius of 0.2 mm was used. As shown in Table 8, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 7, relative to Example 1, an optical unit having a round part with a curvature radius of 1.0 mm was used. As shown in Table 8, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 8, relative to Example 1, an optical unit having a round part with a curvature radius of 1.1 mm was used. As shown in Table 8, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 9, relative to Example 1, an optical unit having a length of the chamfered part of 0.05 mm was used. As shown in Table 8, no change was found in the thermal shock resistance test, which was good. No peeling and no change in color of the internal view of lens were found in the cleaning resistance test. The internal reflectance was less than 40%, which was good. The productivity was in an allowable range, though 1 to 2 pieces had occurrence of tiny chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 10, relative to Example 1, an optical unit having a length of the chamfered part of 0.35 mm was used.

As shown in Table 8, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 11, relative to Example 1, an optical unit having a length of the chamfered part of 0.4 mm was used. As shown in Table 9, although a slight change in color tone was found in the thermal shock resistance test, the change was in an allowable range. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good.

The average particle size was 200 nm or less, which was good.

In Example 12, relative to Example 1, an optical unit having a maximum diameter of 5 mm was used. As shown in Table 9, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 13, relative to Example 1, an optical unit having a maximum diameter of 300 mm was used. As shown in Table 9, although a slight change was found in the thermal shock resistance test, the change was in an allowable range. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 14, relative to Example 1, an optical unit having a maximum diameter of 4 mm was used. As shown in Table 9, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good. Incidentally, due to the small size of the lens, the bonding took time.

In Example 15, relative to Example 1, an optical unit having a maximum diameter of 310 mm was used. As shown in Table 9, although a slight change was found in the thermal shock resistance test, the change was in an allowable range. In the cleaning resistance test, although no peeling was found, a slight change in color of the internal view of lens was found in an allowable range. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 16, relative to Example 1, an optical unit having a difference in the linear expansion coefficient between the first optical element and the second optical element of 5 ppm was used. Incidentally, as the first monitor glass, S-FPL55 (manufactured by OHARA Inc., linear expansion coefficient: 13.6 ppm), and as the second monitor glass, TIH53 (manufactured by OHARA Inc., linear expansion coefficient: 8.8 ppm) were used, respectively. As shown in Table 10, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 17, relative to Example 1, an optical unit having a difference in the linear expansion coefficient between the first optical element and the second optical element of 14 ppm was used. Incidentally, as the first monitor glass, S-FPL53 (manufactured by OHARA Inc., linear expansion coefficient: 14.5 ppm), and as the second monitor glass, quartz (manufactured by Toray, linear expansion coefficient: 0.5 ppm) were used, respectively. As shown in Table 10, although a slight change was found in the thermal shock resistance test, the change was in an allowable range. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 18, relative to Example 1, an optical unit having a difference in the linear expansion coefficient between the first optical element and the second optical element of 4 ppm was used. Incidentally, as the first monitor glass, S-FPM3 (manufactured by OHARA Inc., linear expansion coefficient: 11.5 ppm), and as the second monitor glass, S-LAM2 (manufactured by OHARA Inc., linear expansion coefficient: 7.4 ppm) were used, respectively. As shown in Table 10, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 19, relative to Example 1, an optical unit having a difference in the linear expansion coefficient between the first optical element and the second optical element of 0.1 ppm was used. Incidentally, as the first monitor glass, S-LAH65 (manufactured by OHARA Inc., linear expansion coefficient: 6.0 ppm), and as the second monitor glass, S-LAH53 (manufactured by OHARA Inc., linear expansion coefficient: 5.9 ppm) were used, respectively. As shown in Table 10, no change was found in the thermal shock resistance test, which was good. No peeling and no change in color of the internal view of lens were found in the cleaning resistance test, which was good. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 20, relative to Example 1, an optical unit with a groove part wiped off to have a controlled film thickness of the light-shielding film of 20 μm was used. As shown in Table 10, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 21, relative to Example 1, an optical unit with a groove part multiple-coated to have a controlled film thickness of the light-shielding film of 180 μm was used. As shown in Table 11, no change was found in the thermal shock resistance test, which was good. No peeling and a small change in color of the internal view of lens were found in an allowable range in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 22, relative to Example 1, an optical unit with the light-shielding coating material wiped off to have a controlled film thickness of the light-shielding film of 18 μm was used. As shown in Table 11, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 23, relative to Example 1, an optical unit with the light-shielding coating material multiple-coated to have a controlled film thickness of the light-shielding film of 190 μm was used. As shown in Table 11, a small change was found in an allowable range in the thermal shock resistance test. No peeling and a small change in color of the internal view of lens were found in an allowable range in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 24, relative to Example 1, an optical unit with the light-shielding film controlled to have an elastic modulus of 3000 MPa at −30° C. was used. As shown in Table 11, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 25, relative to Example 1, an optical unit with the light-shielding film controlled to have an elastic modulus of 4900 MPa at −30° C. was used. As shown in Table 11, although a slight change was found in the thermal shock resistance test, the change was in an allowable range. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 26, relative to Example 1, an optical unit with the light-shielding film controlled to have an elastic modulus of 2500 MPa at −30° C. was used. As shown in Table 12, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 27, relative to Example 1, an optical unit with the light-shielding film controlled to have an elastic modulus of 5100 MPa at −30° C. was used. As shown in Table 12, although a slight change was found in the thermal shock resistance test, the change was in an allowable range. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 28, relative to Example 1, a light-shielding film including inorganic particles B was used. As shown in Table 12, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 29, relative to Example 1, a light-shielding film including inorganic particles C was used. As shown in Table 12, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 30, relative to Example 1, a light-shielding film including colorant B was used. As shown in Table 12, no change was found in the thermal shock resistance test, which was good. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Example 31, relative to Example 1, a light-shielding film including a dispersant B having an amine value/acid value of less than 1 was used. As shown in Table 12, no change was found in the thermal shock resistance test, which was good, with the internal view slightly worsened in an allowable range. No peeling and no change in color of the internal view of lens were found in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or more, which was worsened within an allowable range.

TABLE 7

| | Example 1 | Example 2 | Example 3 | Example 4 | Example 5 |
|---|---|---|---|---|---|
| Thermal shock resistance | A | A | A | A | A |
| Cleaning resistance | A | A | A | A | A |
| Internal reflectance | A | B | B | A | A |
| Productivity (defect rate) | A | A | A | B | A |
| Elastic modulus | A | A | A | A | A |
| Color | A | A | A | A | A |
| Average particle size | A | A | A | A | A |

TABLE 8

| | Example 6 | Example 7 | Example 8 | Example 9 | Example 10 |
|---|---|---|---|---|---|
| Thermal shock resistance | A | A | A | A | A |
| Cleaning resistance | A | A | A | A | A |
| Internal reflectance | A | A | A | A | A |
| Productivity (defect rate) | A | A | A | B | A |
| Elastic modulus | A | A | A | A | A |
| Color | A | A | A | A | A |
| Average particle size | A | A | A | A | A |

TABLE 9

| | Example 11 | Example 12 | Example 13 | Example 14 | Example 15 |
|---|---|---|---|---|---|
| Thermal shock resistance | B | A | B | A | B |
| Cleaning resistance | A | A | A | A | B |
| Internal reflectance | A | A | A | A | A |
| Productivity (defect rate) | A | A | A | A | A |
| Elastic modulus | A | A | A | A | A |
| Color | A | A | A | A | A |
| Average particle size | A | A | A | A | A |

TABLE 10

| | Example 16 | Example 17 | Example 18 | Example 19 | Example 20 |
|---|---|---|---|---|---|
| Thermal shock resistance | A | B | A | B | A |
| Cleaning resistance | A | A | A | B | A |
| Internal reflectance | A | A | A | A | A |
| Productivity (defect rate) | A | A | A | A | A |
| Elastic modulus | A | A | A | A | A |
| Color | A | A | A | A | A |
| Average particle size | A | A | A | A | A |

TABLE 11

| | Example 21 | Example 22 | Example 23 | Example 24 | Example 25 |
|---|---|---|---|---|---|
| Thermal shock resistance | A | A | B | A | B |
| Cleaning resistance | B | A | B | A | A |
| Internal reflectance | A | A | A | A | A |
| Productivity (defect rate) | A | A | A | A | A |
| Elastic modulus | A | A | A | A | A |
| Color | A | A | A | A | A |
| Average particle size | A | A | A | A | A |

TABLE 12

| | Example | Example | Example | Example | Example | Example |
|---|---|---|---|---|---|---|
| | 26 | 27 | 28 | 29 | 30 | 31 |
| Thermal shock resistance | A | B | A | A | A | A |
| Cleaning resistance | A | A | A | A | A | A |
| Internal reflectance | A | A | A | A | A | A |
| Productivity (defect rate) | A | A | A | A | A | A |
| Elastic modulus | A | A | A | A | A | A |
| Color | A | A | A | A | A | A |
| Average particle size | A | A | A | A | A | B |

### Comparative Examples 1 to 2

In Comparative Examples 1 to 2, a light-shielding film was prepared in the same manner as in Example 1, except that the materials and conditions in Table 13 were used.

In Table 13, the materials and mixing ratios of the coating materials and curing agents in Comparative Examples 1 to 2 are shown.

In Table 14, the evaluation results of Comparative Examples 1 to 2 with use of the coating materials and curing agents in Table 13 are shown.

In Comparative Example 1, relative to Example 1, a light-shielding film having a resin ratio of 86 vol % was used. As shown in Table 14, cracking of a lens occurred in the thermal shock resistance test. Peeling occurred in the cleaning resistance test. The internal reflectance was less than 40%, which was good. The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

In Comparative Example 2, relative to Example 1, a light-shielding film having a resin ratio of 96 vol % was used. As shown in Table 14, no change was found in the thermal shock resistance test, which was good. No peeling and no change in color of the internal view of lens were found in the cleaning resistance test. The internal reflectance was more than 60%, which was poor.

The productivity was good without occurrence of chipping. Since the elastic modulus was 3000 MPa or more and 4900 MPa or less at −30° C., the film was good. Regarding the color, since the L* value was less than 5, the film was good. The average particle size was 200 nm or less, which was good.

TABLE 13

| | | | Comparative | Comparative |
|---|---|---|---|---|
| | | | Example 1 | Example 2 |
| Shape of | Curvature radius of | | 0.3 | 0.3 |
| monitor | round part (mm) | | | |
| glass | Chamfer length of first | | 0.3 | 0.3 |
| | optical element (mm) | | | |
| | Diameter of optical unit (mm) | | 65 | 65 |
| | Difference in linear expansion | | 13 | 13 |
| | coefficient between first optical | | | |
| | element and second optical | | | |
| | element (ppm) | | | |
| Light- | Resin ratio (vol %) | | 86 | 96 |
| shielding | Resin ratio (wt %) | | 68 | 89 |
| film | Film thickness (μm) | | 60 | 60 |
| | Elastic modulus | | 4000 | 4000 |
| | at −30° C. (Mpa) | | | |
| Light- | Inorganic | Material | Inorganic | Inorganic |
| shielding | particle | | particle A | particle A |
| coating | | Amount added | 200 | 200 |
| material | Colorant | Material | Colorant A | Colorant A |
| | | Amount added | 40 | 40 |
| | Dispersant | Material | Dispersant A | Dispersant A |
| | | Amine value/Acid | 1 or more | 1 or more |
| | | value | | |
| | | Amount added | 60 | 60 |
| | Solvent | Material | Solvent A | Solvent A |
| | | Amount added | 400 | 400 |
| | Main agent | Material | Epoxy resin A | Epoxy resin A |
| | | Amount added | 255 | 1200 |
| | Coupling | Material | Coupling | Coupling |
| | agent | | agent A | agent A |
| | | Amount added | 20 | 20 |
| | Curing | Material | Curing | Curing |
| | agent | | agent A | agent A |
| | | Amount added | 180 | 710 |

TABLE 14

| | Comparative | Comparative |
|---|---|---|
| | Example | Example |
| | 1 | 2 |
| Thermal shock resistance | C | A |
| Cleaning resistance | C | A |
| Internal reflectance | A | C |
| Productivity (defect rate) | A | A |
| Elastic modulus | A | A |
| Color | A | A |
| Average particle size | A | A |

### INDUSTRIAL APPLICABILITY

The optical unit, light-shielding film and light-shielding coating material of the present invention can be used in the lens barrel of an optical apparatus such as a camera, video equipment and broadcasting equipment, and in a camera body, video equipment body, monitoring camera, vehicle-mounted camera, and weather camera which may be used outdoors.

According to the present invention, provided are an optical unit including a cemented lens having a chamfered part to which a stress tends to be applied, with a light-shielding film formed on the edge part, which suppresses occurrence of cracking of the lens even under severe thermal shock, having high cleaning resistance and high performance to prevent internal reflection; a light-shielding film; and a light-shielding coating material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-155705, filed Sep. 21, 2023, and No. 2024-024594, filed Feb. 21, 2024, which are hereby incorporated by reference herein in their entirety.

What is claimed is:

1. An optical unit comprising:
a first optical element,
a second optical element,
a third optical element that joins the first optical element to the second optical element, and
a light-shielding film containing a resin and inorganic particles, disposed in contact with edge faces of the first optical element, the second optical element and the third optical element,
wherein the first optical element and/or the second optical element has a chamfered part on the joint surface side,
wherein at least one of the first optical element and/or the second optical element having the chamfered part has a round part on the joint surface side, and
wherein a resin ratio in the light-shielding film is 87 vol % or more and 95 vol % or less.

2. The optical unit according to claim 1,
wherein the first optical element and the second optical element have a chamfered part on the joint surface side,
wherein the first optical element and second optical element having the chamfered part have a round part on the joint surface side.

3. The optical unit according to claim 1,
wherein the light-shielding film has a first part in contact with the first optical element, a second part in contact with the second optical element, and a third part in contact with the third optical element,
wherein a maximum thickness of the third part is thicker than a maximum thickness of each of the first part and the second part.

4. The optical unit according to claim 3,
wherein a side face of the third part is dented from the first part and the second part.

5. The optical unit according to claim 1,
wherein a length of the chamfered part of the first optical element is 0.05 mm or more and 0.35 mm or less.

6. The optical unit according to claim 1,
wherein a maximum diameter of the optical unit is 45 mm or more and 300 mm or less.

7. The optical unit according to claim 1,
wherein a difference in linear expansion coefficient between the first optical element and the second optical element is 5 ppm or more and 20 ppm or less.

8. The optical unit according to claim 1,
wherein a maximum film thickness of a part of the light-shielding film in contact with the third optical element is 20 μm or more and 180 μm or less.

9. The optical unit according to claim 1,
wherein the round part has a curvature radius of 0.05 mm or more and 1.0 mm or less.

10. The optical unit according to claim 1,
wherein the light-shielding film has an elastic modulus of 2500 MPa or more and 5100 MPa or less at −30° C.

11. The optical unit according to claim 1,
wherein the light-shielding film contains a dispersant having an amine value higher than an acid value.

12. An optical apparatus comprising:
a casing and the optical unit according to claim 1 disposed in the casing.

13. An image pickup apparatus comprising:
a casing, an optical system including the optical unit according to claim 1 disposed in the casing, and an image pickup element that receives light incident through the optical system.

14. A light-shielding film disposed in contact with edge faces of a first optical element, a second optical element, and a third optical element that joins the first optical element to the second optical element comprising:
a resin and inorganic particles;
wherein the light-shielding film has a resin ratio of 87 vol % or more and 95 vol % or less.

15. The light-shielding film according to claim 14,
wherein a maximum film thickness of a part of the light-shielding film in contact with the third optical element is 20 μm or more and 180 μm or less.

16. The light-shielding film according to claim 14, having an elastic modulus of 2500 MPa or more and 5100 MPa or less at −30° C.

17. The light-shielding film according to claim 14, comprising a dispersant having an amine value higher than an acid value.

18. A light-shielding coating material in black color comprising a resin, a colorant, inorganic particles, and a dispersant having an amine value higher than an acid value.
